(19) United States
(12) Patent Application Publication
(10) Pub. No.: US 2011/0142418 A1
(43) Pub. Date: Jun. 16, 2011

(54) BLOCKINESS AND FIDELITY IN WATERMARKING

(76) Inventors: Shan He, Princeton, NJ (US); Jeffrey Adam Bloom, West Windsor, NJ (US); Dekun Zou, Princeton, NJ (US)

(21) Appl. No.: 12/737,783

(22) PCT Filed: Aug. 20, 2009
(86) PCT No.: PCT/US2009/004752

§ 371 Date: Feb. 15, 2011

Related U.S. Application Data
(60) Provisional application No. 61/189,586, filed on Aug. 20, 2008.

(51) Int. Cl. H04N 9/80

(52) U.S. Cl. 386/260; 386/E09.011

(57) ABSTRACT

A device to measure pressure is disclosed. In one embodiment, the device comprises at least one element comprising two layers (24, 26) separated by a space, wherein a dimension of the space changes over a variable time period in response to a voltage applied across the two layers and a measuring module configured to measure the time period, wherein the time period is indicative of the ambient pressure about the device.

### CROSS REFERENCE

This patent application claims the benefit of and priority to U.S. Provisional Patent Application No. 61/189,586, filed Aug. 20, 2008, and titled “BLOCKINESS AND FIDELITY”. The provisional application is expressly incorporated herein by reference in its entirety for all purposes.

### FIELD OF THE INVENTION

The present invention relates to a process for predicting and characterizing visibility of artifacts associated watermarks using a baseline luminance fidelity model and a blockiness fidelity model.

### BACKGROUND OF THE INVENTION

Watermark embedding in a video stream is often required to be not noticeable, but at times introduces visible artifacts. Therefore, a need exists to develop an objective visibility measurement that can identify the changes that will introduce visible artifacts so that watermarks that cause these changes can be avoided.

### SUMMARY OF THE INVENTION

A method comprises providing potential watermarks to apply to video, determining based on luminance whether the potential watermarks are visible or objectionable, determining based on blockiness whether the watermarks are visible or objectionable, and applying watermarks which have been determined to not be visible to a human observer. The video is divided into frames and the frames are divided into blocks. The luminance values and blockiness values are determined for the blocks to which a proposed watermark is directly applied. Additionally, propagation paths can be constructed for changes associated with the watermarks such that the luminance values and blockiness values are determined only for blocks in the propagation path. The propagation path can apply to a current frame due to both intra-prediction or inter-prediction. The propagation path can provide changes in the luminance values for blocks to which the watermarks are directly applied and can provide changes for blocks indirectly changed. The method can further collect absolute luminance changes for each macroblock within changed blocks and can compare the maximum absolute luminance change in a changed block to a threshold luminance level for visibility or objectionability.

Additionally, a video system comprises a processor adapted to collect a plurality of potential watermarks to video, a luminance calculator adapted to calculate a change in luminance to the video associated with the application of the potential watermarks, a blockiness calculator adapted to calculate blockiness of the video associated with the application of the potential watermarks, and a list collector adapted to collect watermarks that do not exceed threshold luminance and blockiness values. The system can be a video encoder, a decoder, a post-processor processing output from a decoder, a pre-processor providing input to an encoder, or the like, wherein the threshold luminance and blockiness values are levels below which the changes to luminance and the blockiness are not perceptible to a human viewer.

### BRIEF DESCRIPTION OF THE DRAWINGS

The invention will now be described by way of example with reference to accompanying drawings.

FIG. 1 is a block diagram of an embodiment of the invention that employs a baseline luminance fidelity model based on absolute luminance difference.

FIG. 2 is a block diagram of an embodiment of the invention that employs a fidelity model based on absolute luminance difference and blockiness measurements.

FIG. 3 is a more detailed embodiment of the invention showing the implementation of fidelity models based on absolute luminance difference and blockiness measurements.

FIG. 4 is an illustration of propagation map.

FIG. 5 is a block diagram illustrating the construction of propagation map.

FIG. 6 is a frame segment being divided for blockiness characterization.

### DESCRIPTION OF THE INVENTION

The invention provides a means for predicting the visibility of artifacts associated with prospective watermarks. The means for predicting visibility are measurements based on luminance fidelity model and a blockiness fidelity model. With these measurements, prospective watermarks which would produce objectionable visible artifacts can be avoided and watermarks which do not produce objectionable or visible artifacts can be employed.

It is important to point out that the invention is particularly useful to H.264/AVC video watermarking or any video encoding in which many blocking artifacts can be introduced by the embedding due to the motion vector change in inter-prediction and reference pixel change in intra-prediction. To avoid these blocking artifacts, a blockiness fidelity measure has been developed and is described in detail later in this specification.

Furthermore, the invention is intended to include modifying a CABAC-encoded H.264/AVC stream and for generating a list of CABAC (Context-based Adaptive Binary Arithmetic Coding)/AVC (Advanced Video Coding) compliant changes. In one embodiment, each entry in the resulting list identifies a specific syntax element, its original value, and a candidate alternative value. A syntax element that appears in this list is considered a changeable syntax element and can appear in the list more than once, each time with a different candidate alternative value.

A subset of the entries in this list can be selected and used for watermarking. An embodiment of the invention distinguishes changes that will introduce visible artifacts and those that will not and accordingly label the changes as visible or invisible, respectively, such that the classification is similar to one preformed by a human observer. Hence, those changes that will introduce visible artifacts can be removed from consideration, thereby leaving a subset of candidate alternative values that can be used to implement an invisible watermark.

### 1. Baseline Luminance Fidelity Model Component

The luminance fidelity model is herein referred to as the baseline fidelity model. As a first approximation, a change will be classified visible if it results in a large absolute change of the luminance values in the block directly affected by the change.

In the baseline fidelity model, a visibility measure is compared with a threshold. Consider first, a visibility measure for a single 16×16 macroblock. The visibility measure is the sum of the absolute luminance change within the block. This visibility measure, denoted AbsDiffⱼ for macroblock j, is formulated as

$${AbsDiff}_{j} = {\sum }_{i ∈ {macroblk}_{j}} \vert {x}_{marked} ( i ) - {x}_{org} ( i ) \vert$$

where x_{org}(i) is the luminance of pixel i in macroblock j of the original, unmarked picture and x_{marked}(i) is the luminance of the same pixel in the watermarked version of the macroblock. For a threshold, h, the changes in block j are classified visible if AbsDiffⱼ≧h, and they are classified invisible if AbsDiffⱼ<h. The changes classified as visible can be removed from the embedding list to avoid visual artifacts in the watermarked content. It is important to point out that a lower threshold h will help filter out more visible artifacts. However, it may also filter out many invisible watermarks leading to fewer changeable blocks for embedding. On the other hand, higher threshold can provide more changeable blocks but at the risk of introducing visual artifacts. The threshold can be adjusted to achieve the desired tradeoff.

In H.264/AVC video coding, a change of a block may propagate to other blocks due to intra-prediction and inter-prediction. Thus, in addition to the block directly affected by a change, there may be a number of blocks indirectly affected. These blocks affected by the change are collectively called propagation path or propagation map. A propagation path is described as how a single change propagates within the same frame.

Propagation mapping capabilities can be integrated in H.264 decoders. As such, propagations maps can be generated which can describe how a single change will propagate through space. An algorithm builds a propagation map to track the affected blocks and their changes. Propagation mapping is useful in many aspects. It can be used to examine the visual distortion resulting from a change. It can be used to avoid (1) changes that may result in overlapping propagation maps, (2) changes that may fall in the propagation path of a previous change or (3) multiple changes that combine such that a third block is affected by both. Propagation maps can be used to improve the detection region when these changes are employed for watermarking.

With digital watermarking being an application that modifies an H.264/AVC encoded video, it is herein recognized that some changes can unexpectedly propagate to other areas of the picture or frame. If a map indicates all of the areas to which a change will propagate, the fidelity assessment can be applied to all of those areas. An additional concern in watermarking is that one may want to make multiple changes in a slice of a block. In watermarking it is important to know what effect a change will have on the decoded imagery and often this is expressed as a change from the unmarked version of the content. However, if a previous change has already propagated to the current region and another change is made, the resulting decoded imagery may include the effects of both changes. If the first change is known, then the result can be predicted, but one may not know a priori whether or not the first change will be employed. If a map were constructed indicating all of the areas to which a change will propagate, then one can avoid making other changes inside of that propagation path. A combination of these two problems can also occur. If a region of a picture is modified indirectly, because a change in a different region has propagated to the current region, the current region can be examined in an assessment of the fidelity impact of that change. However, it is possible that there are multiple changes, all of which can propagate into the current region. If maps of the propagation paths of all the changes are available, one can identify the regions of overlapping propagation and can consider all combinations of impacts.

FIG. 4(a) shows an example propagation map. This propagation map 400 is associated with one block 410 whose motion vector has been directly changed. The other blocks 420 in the figure are blocks that will be indirectly changed due to propagation. When a block changes, either due to a direct modification or because it falls in the propagation path of another change, the change has the potential to further propagate to its neighbors. FIG. 4(b) illustrates the four neighbors 440 whose luminance values might be modified due to this propagation, when only one block 430 was directly changed. The propagation map, P, of a changed block represents a collection of the blocks, p, whose luminance values are also changed due to propagation. Each block in the propagation map is represented with a data structure indicating the initial change, the prediction mode of the current block, and the change in the current block and is denoted as:
p={head_node_info, mode, cur_node_info}.
   The “head_node” uniquely identifies the changed block in terms of position and the alternative value of the motion vector that initiated the changes. All of the nodes in the propagation map P will have the same “head_node.” The element “mode” indicates the prediction mode of the current block, which can be either intra-prediction or inter-prediction. The element “cur_node” records the information about the current block. The “cur_node” contains the original and new motion vectors for inter-predicted blocks and intra-prediction mode and reference blocks for intra-prediction blocks.

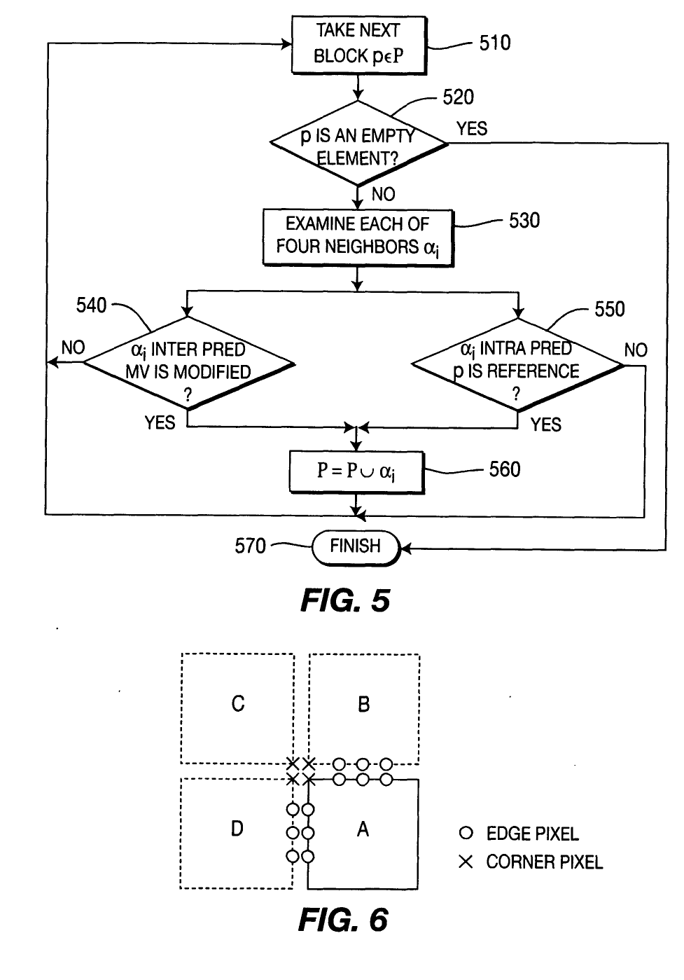

FIG. 5 shows a method for constructing the propagation map. The propagation map, P, is initialized with the changed block p in box 510. Then at evaluation box 520, a determination is made to evaluate whether block p is empty. If block p is not empty, then each of the block p neighbors αᵢ, i=1, . . . , 4 is examined in examination box 530. For the example configuration in FIG. 4b block p has 4 neighbors. The goal of each of these examinations is to determine if the change to block p will propagate to neighbor αᵢ. To do this, the decoding using the original values associated with p as well as the changed values can be compared. If block αᵢ is an inter-predicted block, then in the inter-prediction pathway 540, one can examine the motion vector predicted using the new motion vector of p and those of the other neighbor blocks. If it is different from the original motion vector, then the change will propagate to this neighbor and block αᵢ is appended to the propagation map P in the propagation box 560. If αᵢ is intra-predicted in the intra-predicted pathway 550 and block p is used as the reference in the prediction, then the change will propagate to this neighbor and block αᵢ is appended to the propagation map P in the propagation box 560. After all the four neighbors have been examined, the next element in P is considered. This process repeats until there are no new elements in P to arrive at finish box 570.

The invention is intended to include the feature of propagation mapping being integrated into an H.264 decoder in the context of watermarking system in which a previous step has created a list of potential modifications, wherein each potential modification consists of a block identifier, an indication of which motion vector can be modified, and the alternative value for that motion vector. Note that, at this point, there can be a number of potential modifications for a single block. In a later step, the list of potential modifications can preferably be pruned so that no block has more than one modification.

The propagation map P can be represented as a linked list, which, as a whole, will identify the macroblocks/partitions affected by the potential modification. As the decoder processes the macroblocks of B slices (in raster scan order), one can keep adding affected macroblocks/partitions to the corresponding linked lists.

A preferred detailed integrated algorithm will now be described, which is the integration of propagation mapping with an AVC decoder. Given a list of potential modifications in a B-slice containing l entries, each corresponding to a modifiable motion vector with one alternative, l linked lists can be constructed and each list can be initialized to contain one node, the potential modification itself. The sample data structure of the node p is shown in Table 1, which contains the location information of the macroblock/partition, original and new motion vector information.

TABLE 1
Data structure of the linked list for each propagation map

struct propagation map_node
{

| | |
|---|---|
| next; | // pointer to next node |

| /* macroblock/partition information of current block*/ | |
|---|---|
| mbAddr; | // the address of the macroblock w.r.t. the beginning |

of the frame measured

// in the raster scan order

| | |
|---|---|
| mbPartIdx; | // the partition index. |
| subMbPartIdx; | // the sub-macroblock partition index. |

/* motion related information corresponding to the modified

motion vector */

| | |
|---|---|
| MVorg_x; | // x component of the original motion vector of the |

current block.

| | |
|---|---|
| MVorg_y; | // y component of the original motion vector of the |

current block.

| | |
|---|---|
| MVnew_x; | // x component of the modified motion vector of the |

current block.

| | |
|---|---|
| MVnew_y; | // y component of the modified motion vector of the |

current block.

| | |
|---|---|
| refFrmNum; | // the frame number of the reference frame used for |

motion compensation

| | |
|---|---|
| list_id; | // 0 or 1, indicate the list whose motion vector has been |

modified.

| | |
|---|---|
| ref_idx; | // the index of reference frame in list list_id |

| | |
|---|---|
| MVWeight; | // the weight of the motion-compensated prediction |

/* intra-predicted block */

| | |
|---|---|
| Intra-prediction mode; | // −1 for inter prediction, >= 0 for intra |

prediction

Involved neighbors; // record the neighbor blocks involved in the

prediction for further analysis

/* other information */
......

}

Since the process of propagation map building can be integrated into the AVC decoder, most of this information can be directly obtained from the decoder. Other information can be added based on the application of the propagation map.

Now with an understanding of the building of a propagation map, a situation in which a change does not introduce a visible artifact in the block directly affected can be considered, but, as the changes propagate to other blocks, an artifact can be introduced in one of the blocks along the propagation path. Thus, in at least one example, it is important to consider all blocks on the propagation path, not just the block directly affected, when classifying a change.

The luminance visibility measure is easily extended to account for artifacts introduced into the propagation path of a proposed change. To do this, the visibility measure is calculated for every macroblock in the propagation path of a proposed change and a visible measure is derived from all of these. One example of a visibility measure for a propagation path is the worst case (maximum) value. This measure can be denoted MaxAbsDiffₖ for proposed change k and is formulated as

$${MaxAbsDiff}_{k} = {Max}_{j ∈ {PropPath}_{k}} ( {\sum }_{i ∈ {macroblk}_{j}} \vert {x}_{marked} ( i ) - {x}_{org} ( i ) \vert ) .$$

The advantages of this fidelity model are that the fidelity score is easy to calculate and does not introduce much computational cost.

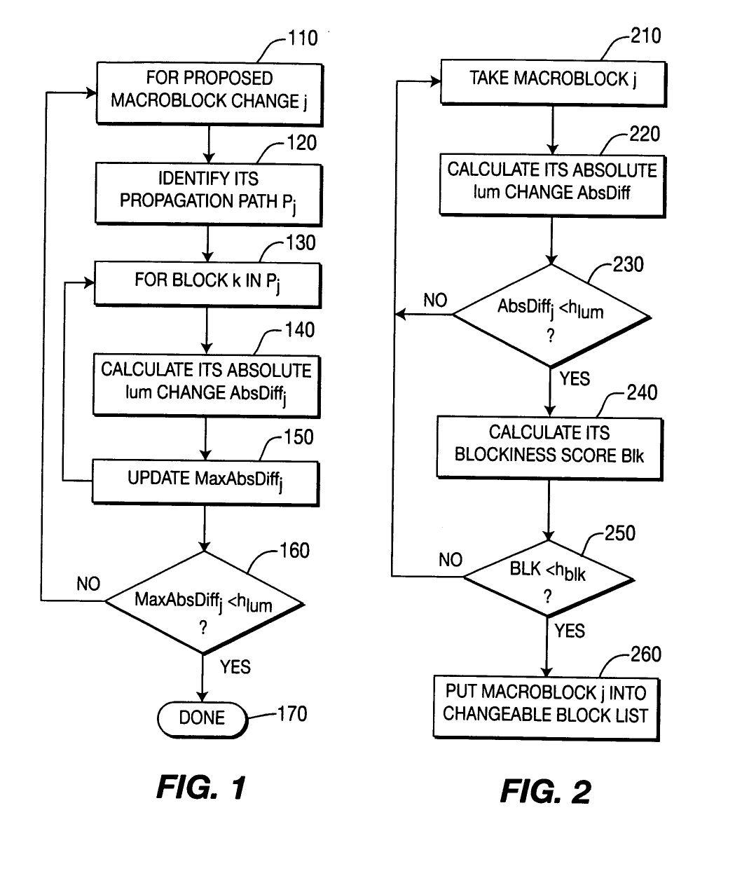

FIG. 1 shows a block diagram of a luminance fidelity model in which proposed macroblock changes j are first made in box 110. This is followed by identifying the propagation path associated with the change in box 120 and considering each of the blocks in the propagation path in box 130. Next, this is followed by calculating or determining absolute luminance change for the blocks in box 140 and determining the worst case value for the macroblock in box 150 and recording or updating the data for each of the macroblocks until each of the macroblocks in block k have been calculated in box 150. If the worst case value is less than the luminance visibility threshold in box 160, then the proposed macroblock changes will be accepted in box 170 and if the worst case value is not less than the luminance visibility threshold, then other proposed macroblock changes will be considered in box 110 and similarly run through the block diagram until acceptable changes are identified.

### 2. Blockiness Fidelity Model

The baseline fidelity model works well, but there are classes of changes that introduce visible artifacts without introducing large luminance changes. The baseline model is limited to finding only those artifacts that are due to large luminance changes.

A second class of artifacts that can be seen by the H.264/AVC watermarking can be blocking artifacts.

A blocking artifact is visible when the pixel values on the edges of a block are correlated with the adjacent pixel values on the corresponding edges of the adjacent blocks in the original picture, but become significantly uncorrelated with those adjacent pixels in the watermarked picture. In this case, a viewer can perceive the edges of the block. When this artifact occurs on all four edges of a block, the artifact appears as an erroneous block of data and is thus called a blocking artifact. The blockiness fidelity model incorporates a blockiness measure in addition to the luminance measure. Changes that cause a high blockiness measurement value or blockiness score are labeled as visible. In other words, the blockiness measure is how blocky the content becomes after certain processing (e.g. compression, watermarking) compared with the original content. If the original content is smooth and the generated content is blocky, then this particular operation will receive a high blockiness score. If the original content is blocky and the processed content is also blocky, then this particular operation will receive low blockiness score. In other words, the blockiness score measures how much blocky artifacts introduced by the processing. By compare the blockiness score with a threshold, the blocks with visible artifacts can be indentified and can be removed, accordingly. The blockiness measure is performed block by block. As shown in Error! Reference source not found.6, for each n×n block A, one can calculate its blocky metric BM and block gradient metric BGM to obtain its final blockiness score. To calculate the BM, one first calculates the blocky metric for each pixel as follows. A metric pᵢ can be for horizontal edge pixel i=2, . . . , n−1, wherein

qᵢ=(B bottom edge pixel i−A top edge pixel i);

if |qᵢ_{_{—}}ₒᵣᵢ|<|qᵢ_{_{—}}processed| && |qᵢ_{_{—}}processed|−<64
pᵢ=|qᵢ_{_{—}}processed|−|qᵢ_{_{—}}ₒᵣᵢ|;

else
pᵢ=0;

pᵢ=>B bottom edge pixel i and A top edge pixel i.

A metric pᵢ can be for vertical edge pixel i=2, . . . , n−1, wherein

qᵢ=(D right edge pixel i−A left edge pixel i);

if |qᵢ_{_{—}}ₒᵣᵢ|<★qᵢ_{_{—}}processed| && |qᵢ_{_{—}}processed|−<|qᵢ_{_{—}}ₒᵣᵢ<64
pᵢ=|qᵢ_{_{—}}processed|−|qᵢ_{_{—}}ₒᵣᵢ|;

else
pᵢ=0;

pᵢ=>D right edge pixel i and A left edge pixel i.

A metric p can be for diagonal corner pixel, wherein

q=(C lower right corner pixel−A upper left pixel);

if |q_ori|<|q_processed| && |q_processed |−|q_ori |<64
p=|q_processed |−|q_ori;

else
p=0;

p=>C lower right corner pixel and A upper left pixel.

A metric p can be for off-diagonal corner pixel:

q=(D upper right corner pixel−B lower left pixel);

if |q_ori|<|q_processed| && |q_processed|−|q_ori|<64
p=|q_processed|−|q_ori|;

else
p=0;

p=>D upper right corner pixel and B lower left pixel.

$$BM = max ( abs ( {\sum }_{i ∈ top \_ row} {p}_{i} ) , abs ( {\sum }_{i ∈ bottom \_ row} {p}_{i} ) , \\ abs ( {\sum }_{i ∈ left \_ column} {p}_{i} ) , abs ( {\sum }_{i ∈ right \_ column} {p}_{i} ) ) / n .$$

BGM is calculated by taking the average of the horizontal and vertical maximum gradient among original block and processed block. For pixels in one block xᵢⱼ, i=1, . . . , n, j=1, . . . , n,

$$BGM = ( {\sum }_{i , j} max ( {x}_{i + 1 j , ori} - {x}_{ij , ori} , {x}_{i + 1 j , proc} - {x}_{ij , proc} ) + {\sum }_{i , j} max ( {x}_{ij + 1 , ori} - {x}_{ij , ori} , {x}_{ij + 1 , proc} - {x}_{ij , proc} ) ) / 2 n ( n - 1 )$$

Finally, the blockiness score for each n×n block is obtained as max(0, BM−BGM).

Since the BD+/AVC watermark is embedded macroblock by macroblock, a natural thinking would be to calculate the blockiness score using 16 as block size. However, the blocks on the propagation map of the change may not necessarily be 16×16. Due to the inter and intra prediction mode, the block size can be 16×8, 8×16, 8×8, and 4×4. If one uses a large n, e.g. 16, as the block size, then the macroblocks where only one of the 8×8 or 4×4 sub-blocks is changed may end up having a low blockiness score even though the changed sub-block is quite blocky. Therefore, the smallest possible block size, 4×4 should be used to calculate the blockiness score and then to sum them to obtain the final score for each 16×16 macroblock. Note that using a smaller block size to calculate the blockiness score has the same computational complexity as the large block size.

By summing the blockiness score of 4×4 sub-blocks to obtain the final score of the macroblock, one takes into account the area of the blocky artifacts. If, for example, all the 16 4×4 blocks have non-zero blockiness score, it means the entire 16×16 macroblock has s blocky artifact and may be more visible than the case where only one sub-block having non-zero score. Alternatively, the highest score from the 16 sub-blocks as the final score for the macroblock can be selected.

This blockiness measure can be applied to any rectangular, or at least piecewise linear, closed region such as a typical block. There are many ways that this can be used in various implementations. Since the BD+/AVC watermark is embedded macroblock by macroblock, a reasonable way would be to calculate the blockiness score using 16×16 as the block size. However, the blocks on the propagation path of the change are not necessarily 16×16. Depending on the inter- and intra-prediction modes, the block size can be 16×8, 8×16, 8×8, or 4×4. If one uses a large block size, e.g. 16, then the macroblocks where only one of the 8×8 or 4×4 sub-blocks is changed may end up having a low blockiness score even though the changed sub-block is quite blocky.

At least one disclosed implementation uses the smallest possible block size, 4×4, to calculate the blockiness score, and then add up the scores from the 16 adjacent 4×4 blocks to obtain the final score for each 16×16 macroblock. Note that using a smaller block size to calculate the blockiness score has the same computational complexity as the large block size.

By summing up the blockiness score of 4×4 sub-blocks to obtain the final score of the macroblock, one takes into account the area of the blocky artifacts. If, for example, each of the 16 4×4 blocks has a non-zero blockiness score, it means the entire 16×16 macroblock has blocking artifacts which may be more visible than the case where only one sub-block has a non-zero score. An alternative embodiment is to select the highest score from the 16 sub-blocks as the final score for the macroblock. By doing that, one focuses on the 4×4 block with the highest blockiness score, which most likely will cause visual artifact.

FIG. 2 is a block diagram of the blockiness fidelity model based on both absolute luminance difference and blockiness measure. In this model, one compares the luminance measure with a threshold. First, a change to macroblock j is considered in box 210 and the absolute luminance change associated with the change is calculated in box 220. Changes that result in a luminance measure that exceeds the threshold are classified as visible in decision box 230. If the absolute luminance change is visible, then in decision box 230, one considers another change in macroblock j in box 210. On the other hand, if the change is not visible by the luminance measure in 230, then a blockiness score is calculated. The blockiness score is then compared with a blockiness threshold in decision box 250. Changes that result in a blockiness score that exceeds the blockiness threshold are classified as visible; as such, they are not placed in a changeable block list and another change is then considered in box 210. Those changes that result in both a luminance measure that is below the luminance threshold and a blockiness score that is below the blockiness threshold are classified as not visible and are placed in the allowed changeable block list in box 260.

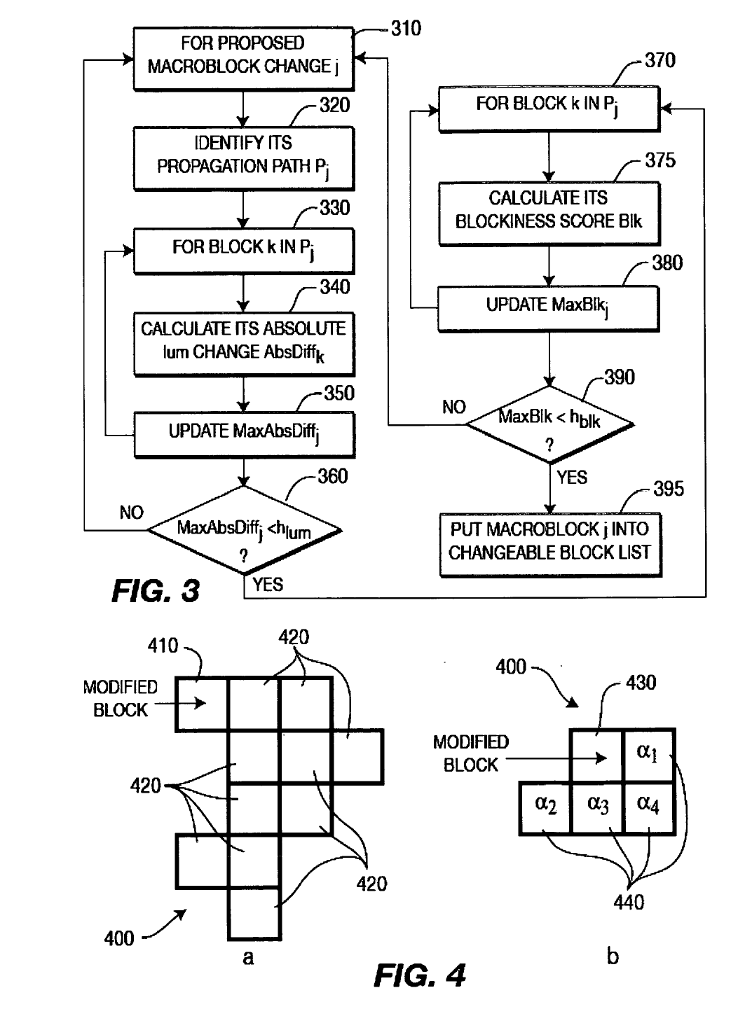

FIG. 3 shows a detailed block diagram of an enhanced fidelity model in which a proposed macroblock change j is first made in box 310. This is followed by identifying the propagation path associated with the change in box 320 and considering each of the blocks in the propagation path in box 330. Next, this is followed by calculating the absolute luminance change for the blocks in 340 and determining the worst case value for the macroblock in box 350. This visibility measure for a propagation path is the worst case (maximum) value. If the worst case value is less than the luminance visibility threshold in decision box 360, then the proposed macroblock change will be accepted and the process is advanced to box 370 to consider the accepted proposed macroblock from box 360. If the worst case value is not less than the luminance visibility threshold in box 360, then another proposed macroblock change j will be considered in box 310. Once a macroblock change is advanced to box 370, the process advances to calculating the blockiness score in box 375 and determining the maximum blockiness value in box 380. The blockiness score in box 375 is compared with a blockiness threshold in decision box 390. Changes that result in a blockiness score that exceeds the blockiness threshold are classified as visible, and as such, are not placed in a changeable block list. Rather another change is then considered in box 310. Those changes that result in both a luminance measure that is below the luminance threshold and a blockiness score that is below the blockiness threshold are classified as not visible and are placed in the allowed changeable block list in box 395.

Similar to the baseline mode, the visibility measure is used to account for artifacts introduced along the propagation path of a proposed change. The blockiness score is calculated for every macroblock in the propagation path of a proposed change and the maximum value is used. This measure is denoted as MaxBlkₖ for proposed change k and is formulated as

$${MaxBlk}_{k} = {Max}_{j ∈ {PropPath}_{k}} ( {Blk}_{j} ) ,$$

where Blkⱼ is the blockiness score for block j. Here MaxBlkₖ is compared with the blockiness threshold to determine if the proposed change k could introduce visible artifacts.

Several of the implementations and features described in this application may be used in the context of the H.264/MPEG-4 AVC (AVC) standard. However, these implementations and features may be used in the context of another standard (existing or future), or in a context that does not involve a standard.

The embodiments described herein may be implemented in, for example, a method or process, an apparatus, a software program, a datastream, or a signal. Even if only discussed in the context of a single form of implementation such as a method, the implementation or features discussed may also be implemented in other forms such as an apparatus or program. An apparatus may be implemented in, for example, appropriate hardware, software, and firmware. The methods may be implemented in, for example, an apparatus such as, for example, a computer or other processing device. Additionally, the methods may be implemented by instructions being performed by a processing device or other apparatus, and such instructions may be stored on a computer readable medium such as, for example, a CD, or other computer readable storage device, or an integrated circuit. Further, a computer readable medium may store the data values produced by an implementation.

As should be evident to one of skill in the art, implementations may also produce a signal formatted to carry information that may be, for example, stored or transmitted. The information may include, for example, instructions for performing a method, or data produced by one of the described implementations. For example, a signal may be formatted to carry a watermarked stream, an unwatermarked stream, a fidelity measure, or other watermarking information.

While embodiments throughout the specification have focused on changes to video that are introduced to watermarking, this invention includes the application of the various combinations of features to proposed changes to video that are not necessarily watermarks.

Additionally, in some case the metrics and methods disclosed herein can be used to keep or select watermarks or changes because they will be visible to a human observer.

Additionally, many embodiments may be implemented in one or more of an encoder, a decoder, a post-processor processing output from a decoder, or a pre-processor providing input to an encoder. Further, other implementations are contemplated by this disclosure. For example, additional implementations may be created by combining, deleting, modifying, or supplementing various features of the disclosed implementations.

1. A method comprising:
providing a possible watermark applicable to video;
determining responsive to luminance values whether the watermark is visible;
determining responsive to blockiness whether the watermark is visible; and
applying or not applying the watermark to video responsive to the luminance values and blockiness in the determining steps.

2. The method of claim 1 further comprising:
selecting the watermark from a plurality of proposed watermarks.

3. The method of claim 2 wherein frames of the video are divided into blocks and the method further comprises:
determining a change in the luminance values for the blocks to which the watermark is directly applied.

4. The method of claim 3 further comprising:
determining a propagation path that provides changes in the luminance values for blocks to which the watermark is directly applied and provides changes in luminance values for blocks in a current frame due to intra-prediction or due to inter-prediction.

5. The method of claim 2 further comprising:
determining a propagation path that provides changes in the luminance values for blocks to which the watermark is directly applied and provides changes in luminance values for other blocks indirectly changed;
selecting a proposed watermark that has been determined to not be visible based on luminance for macroblocks in the blocks in the propagation path;
determining a blockiness score for the blocks;
placing macroblock data into acceptable block list for macroblocks not visible based on blockiness.

6. A method comprising:
providing a plurality of changes to video, wherein the video is partitioned into blocks and the blocks are partitioned in macroblocks;
determining an absolute luminance change for a change to one macroblock in one block;
determining if the luminance change is visible and filtering out the change responsive to visibility based on absolute luminance change;
determining blockiness of the change if the change is not visible based on the absolute luminance change;
determining if the blockiness of the change is visible and filtering out the change responsive to visibility based on blockiness; and
adding or not adding the change to a changeable block list responsive to visibility based on blockiness.

7. The method of claim 6 comprising:
establishing a propagation map which determines each of the blocks of video that are affected by the change;
collecting absolute luminance changes for each macroblock in the propagation map; and
comparing the maximum absolute luminance change in the propagation map to a threshold luminance level for visibility.

8. The method of claim 7 comprising:
selecting each of the remaining blocks in the propagation map one by one and processing them and their macroblocks as the one block.

9. The method of claim 6 comprising:
establishing a propagation map which determines each of the blocks of video that are affected by the change;
collecting a blockiness score for blocks in the propagations; and
comparing the blockiness score of the blocks to a blockiness threshold value for visibility.

10. The method of claim 8 comprising:
collecting a blockiness score for blocks in the propagations; and
comparing the blockiness score of the blocks to a blockiness threshold value for visibility, wherein changes that do not exceed the visibility threshold for luminance and blockiness are added to the changeable block list.

11. A system comprising:
a processor adapted to collect or generate a plurality of potential watermarks to video;
a luminance calculator adapted to calculate a change in luminance to the video associated with the application of the potential watermarks;
a blockiness calculator adapted to calculate blockiness of the video associated with the application of the potential watermarks; and
a list collector adapted to collect watermarks that do not exceed threshold luminance and blockiness values.

12. The system of claim 11 wherein the system is a video encoder, a decoder, a post-processor processing output from a decoder, or a pre-processor providing input to an encoder.

13. The system of claim 12 wherein the threshold luminance and blockiness values are level where the changes to luminance and blockiness are not perceptible to a human viewer.

14. The system of claim 11 wherein the processor is adapted for H.264/AVC video watermarking.

15. The system of claim 11 wherein the processor is adapted to modify a CABAC-encoded video stream.

16. The system of claim 11 wherein the list collector or processor is adapted to identify a watermark entry as specific syntax element, an original value, and a candidate alternative value.

17. The system of claim 16 wherein the list collector or processor is adapted to having a given syntax element appear in a list of collected watermarks more than once, wherein a different candidate alternative value is provided for different entries of the given syntax element.

18. The system of claim 17 wherein the list collector or processor is adapted to partition a subset designated for watermarking.
